(19) United States
(12) Patent Application Publication
(10) Pub. No.: US 2004/0150840 A1
(43) Pub. Date: Aug. 5, 2004

(54) METHODS AND SYSTEMS FOR STRUCTURING A RASTER IMAGE FILE FOR PARALLEL STREAMING RENDERING BY MULTIPLE PROCESSORS

(76) Inventors: Michael E. Farrell, Ontario, NY (US); Daniel Fleysher, Pittsford, NY (US); David E. Rumph, Pasadena, CA (US); William S. Jacobs, Los Angeles, CA (US); Thomas Robson, Rochester, NY (US); Mark A. Smith, Rochester, NY (US); Eric J. Thibodeau, Westminster, CA (US)

Correspondence Address: OLIFF & BERRIDGE, PLC., P.O. BOX 19928, ALEXANDRIA, VA, 22320, US

(21) Appl. No.: 10/248,594

(22) Filed: Jan. 30, 2003

(51) Int. Cl. G06F 9/28; G06F 17/00

(52) U.S. Cl. 358/1.1; 715/911

(57) ABSTRACT

Structuring a raster image data file includes accessing image data containing set-up information and image data, determining a structure of the image data, sequencing contents of the image data file such that different parts of the set-up information are grouped together, segmenting the image data, and constructing an output image data file. The structure of image data may include one or more layers. The set-up information may be sequenced to precede the image data. Therefore, segmented image data can be distributed to more than one processor and sequentially processed and reproduced. This results in shortening the printing time.

### BACKGROUND OF THE INVENTION

1. Field of Invention

This invention relates to a raster image file structure for parallel streaming rendering by multiple processors.

2. Description of Related Art

Raster image processing (RIP) of digital front end (DFE) submissions can be quite time consuming. Typical performance for this type of RIP is in the range of one page per minute for a standard letter size 600 dpi (dot per inch) by 600 dpi mode. Since print engine performance directly relates to efficiency in printing, printing a page both faster and with clearer color decomposition is a major bottleneck for color printing performance.

To address these concerns, Adobe Systems Inc. has provided architecture for a system that processes a page independent portable data format (PDF) as a page description language (PDL). The PDF is an object-oriented description of page content, and a raster is one object type. In this system, page parallel RIP process is supported, in which, because each page is independent, i.e., the instructions for any given page are not dependent on proceeding or following pages, processing for pages can be distributed across multiple processors. In the Adobe system, each page may be assigned to and processed at a different processor.

However, even though a plurality of pages are processed at different processors at the same time, which results in shortening the overall processing time, the above-described problems, especially with respect to print speed, are not fully resolved since each whole page still has to be processed by a single processor.

### SUMMARY OF THE INVENTION

This invention provides methods and systems for structuring a raster image data file. The methods and systems according to this invention make processing of a raster image data file more efficient by segmenting the raster image data file.

In exemplary embodiments of the systems and methods according to this invention, structuring a raster image data file includes accessing a data file containing set-up information and image data, determining the structure of the image data, sequencing contents of the image data file such that different parts of the set-up information are grouped together, segmenting the image data, and reconstructing the image data into an output image data file. The structure of the image data may include one or more layers.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail with reference to the following figures, wherein:

FIG. 1 illustrates a first example of a file structured according to this invention;

FIG. 2 illustrates a second example of a file structured according to this invention.

FIG. 3 illustrates a third example of a file structured according to this invention;

FIG. 4 illustrates a block diagram showing an exemplary embodiment of a raster image file structuring apparatus;

FIG. 5 is a diagram showing exemplary segmentation of an image into strips;

FIG. 6 is a diagram showing an exemplary formation of strips from a plurality of layers; and

FIG. 7 is a flowchart outlining one exemplary method for structuring a raster image file.

### DETAILED DESCRIPTION OF EXEMPLARY EMBODIMENTS

A raster image data file structuring apparatus and method according to this invention enables better printing performance by segmenting a received image data file. This is done by, for example, accessing an image data file containing set-up information and image data, determining a structure of the image data, sequencing contents of the image data file such that the set-up information is grouped together and may precede the image data, segmenting the image data into a plurality of segments, and reconstructing the image data into an output image data file. The structure of the image data may include one or more layers.

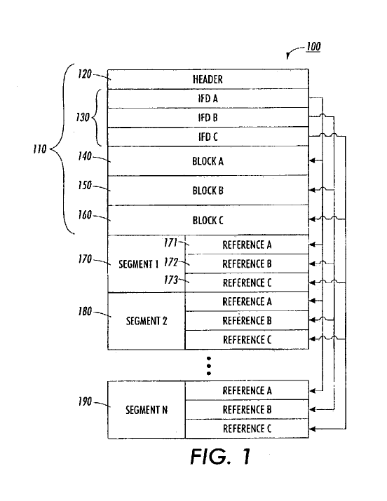

FIG. 1 shows a first exemplary raster image file 100 structured in accordance with this invention. The raster image file 100 may be in any known or later developed format, such as TIFF (Tag Image File Format), JPEG (Joint Photograph Experts Group), or GIF (Graphics Interface Format), including any versions or modifications thereof. In this example, it is assumed that the raster image file 100 is in a TIFF format.

The raster image file 100 includes set-up information 110 that provides information for accurate reproduction of the raster image when the raster image is output. For example, the set-up information 110 may be or include information indicating the file format and various values for accurate representation of the associated raster image, such as image length and width values, compression coefficients and/or other information associated with the raster image data.

In the example shown in FIG. 1, an image file header 120, one or more image file directories (IFD) 130, and one or more blocks 140-160 are grouped together as the set-up information 110, and the set-up information 110 precedes image data. The image data may include separate raster images in different layers, such as foreground and background layers. The IFDs 130 may be provided separately for each separate raster image. Each IFD 130 contains one or more field values, containing information about the image such as bits per sample, X-resolution, Y-resolution, and/or the like, and/or pointers to the image data. It should be appreciated that, while a plurality of IFDs 130 are shown in FIG. 1, some cases may only require a single IFD.

In an exemplary embodiment of the raster image file 100 shown in FIG. 1, detailed information of the image data for each separate raster image may be provided in separate blocks 140-160 succeeding the IFDs 130. In each of blocks 140-160, values needed for accurate rendering of the image data may be provided. For example, tag values for tags, such as strip offsets and strip byte counts and the like are provided in the blocks 140-160. Other values may include information related to rendering hints (e.g., offsets to the rendering hint dictionary which defines the encoding of the rendering hints used in the image), resolution, and/or type of the format of respective raster image in the image data file. In this exemplary embodiment, the IFDs 130 are located before the detailed information of the image data for each separate raster image.

Furthermore, if, for example, the image data contains separate raster images (e.g., has more than one layer), one or more of which are in a JPEG format and another one or more of which are in a non-JPEG format, then rendering characteristics, represented by a quantization table (Q-table), Huffman table or the like, which are usable with the JPEG format, are included in the set-up information.

In the exemplary raster image file 100 shown in FIG. 1, one or more segments, each having a portion of the image data, may be provided in the raster image file 100. In this exemplary embodiment, there are three segments 170-190. Each segment may have a constant size, which may be predetermined or determined based on, for example, a format of image data and/or quality of the image data, and include one or more references referring to one or more values described in the set-up information 110. For example, segment 170 may have a reference 171 including one or more values that depend on one or more values in the block 140. Similarly, segment 170 may have a reference 172 that refers to one or more values in block 150, and a reference 173 that refers to one or more values in block 160. Accordingly, when a segment is assigned to a processor, the segment can be accurately reproduced or rendered by referring to the information provided in the set-up information 110 based on the respective references 171-173.

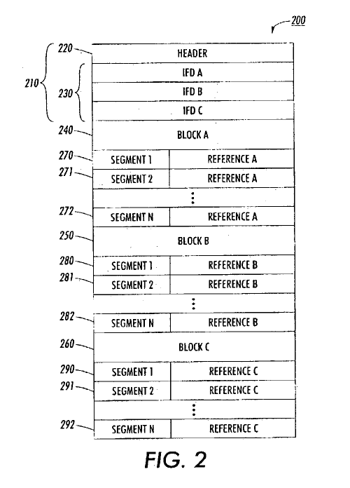

FIG. 2 shows another example of the raster image file according to this invention. In FIG. 2, a raster image file 200 has set-up information 210, which includes a header 220 and IFDs 230. In this example, the references for a block are grouped together. In other words, references 270-272 for segments 1-N, which refer to the block 240, are grouped together and follow the block 240. The block 250 follows the group of references 270-272. Similarly, references 280-282 for segments 1-N, which refer to the block 250, are grouped together and follow the block 250. The block 260 follows the group of references 280-282. References 290-292 for segments 1-N, which refer to the block 260, are grouped together and follow the block 260.

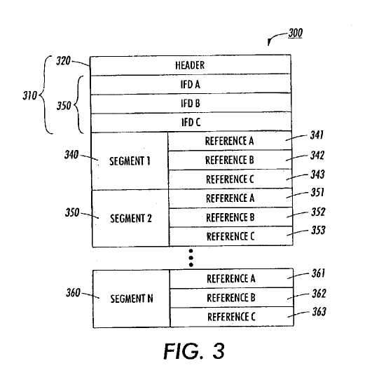

FIG. 3 shows a third example of raster image file 300 structured in accordance with this invention. In this example, only the header 320 and IFDs 330 are provided in the set-up information 310. Each of segments 340, 350 and 360 has blocks 341-343, 351-353 and 361-363, respectively. Similar to the first example, information of the image data is provided in blocks 341-343, 351-353 and 361-363 for the separate segments 340-360, respectively.

The structure shown in FIG. 3 may be particularly advantageous if minimal file size is desired and file interoperability is managed via a separate mechanism, which may be, for example, a simple agreement between the writer and the reader on a common set of characteristics. If each segment contains separate raster images (e.g., separate layers) in a format such as JPEG format, or in different color separations (e.g., cyan, yellow, and magenta), the segments may have rendering characteristics, such as quantization tables or Huffman tables, that are different from rendering characteristics of other segments. In this case, providing separate blocks for a segment is more efficient and accurate for reproduction of the image data since each segment can be individually processed without processing other information needed for other segments.

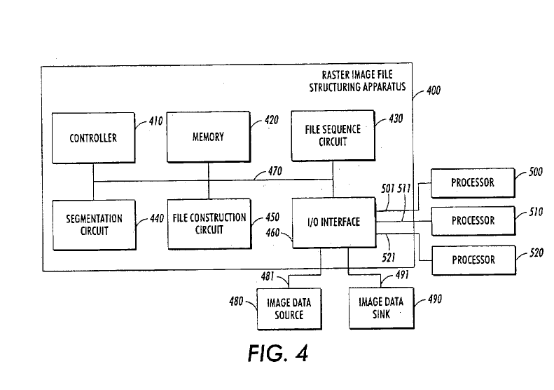

FIG. 4 shows an exemplary embodiment of a raster image file structuring apparatus 400 according to this invention. The raster image file structuring apparatus 400 may be incorporated in a raster image processing system disclosed in a copending, commonly assigned application, Attorney Docket No. 110235, entitled “Systems and Methods for Rapid Processing of Raster Intensive Color Documents,” incorporated herein by reference in its entirety.

The raster image file structuring apparatus 400 includes a controller 410, a memory 420, a file sequence circuit 430, a segmentation circuit 440, a file construction circuit 450 and an input/output (I/O) interface 460, which are connected to each other via a data/control bus 470. The input/output interface 460 provides connections from the raster image file structuring apparatus 400 to the image data source 480 and the image data sink 490 via communication links 481 and 491, respectively. The input/output interface 460 also provides connections between the raster image file structuring apparatus 400 and processors 500, 510 and 520 via communication links 501, 511 and 521, respectively. It should be appreciated that the communication links 501, 511 and 521 need not be separate entities, but may all be included in a bus structure connecting the I/O interface 460 and the processors 500, 510 and 520. In addition, it should be appreciated that the number of processors is not limited to three. The number of the processors may vary depending on the processing speed, amount of data processed at each processor, the number of segments, and the like. Furthermore, it should be appreciated that the processors 500, 510 and 520 need not be entities separate from the raster image file structuring apparatus 400, but may be incorporated therein. Alternatively, the processors 500, 510 and 520 may be incorporated into the image data sink 490.

The image data source 480 can be a locally or remotely located computer capable of sharing data, a locally or remotely located scanner, or any other known or later-developed device that is capable of generating electronic data, such as an electronic document. The image data source 480 may also be a device that can convert such electronic data into an image or a predetermined format, such as the PDF format. The image data source 480 may also be a data carrier, such as a magnetic storage disc, CD-ROM or the like. Similarly, the image data source 380 can be any suitable device that stores and/or transmits electronic media data, such as a client or a server of a network, intranet, or the Internet, and especially the World Wide Web, and/or news groups.

The image data sink 490 can be any known or later-developed device that is capable of outputting or storing the processed electronic data generated using the apparatus and method according to this invention, such as a display device, a printer, a copier or other image forming device, a facsimile device, a memory or the like. In embodiments, the image data sink 490 is a printing device, which receives, from the raster image file structuring apparatus 400 via the communication link 491, data processed by the processors 500, 510 and 520.

The processors 500, 510 and 520 process image data segments received from the raster image file structuring apparatus 400 via the communication links 501, 511, and 521. The processors 500, 510 and 520 may be any known or later-developed devices that are capable of processing such image data segments. In this exemplary embodiment, the processors 500, 510 and 520 are individually provided. However, the processors 500, 510 and 520 may be provided at a different location, such as in the image source 480 and/or the image data sink 490.

It should be appreciated that the image data source 480 and/or the image data sink 490 may be incorporated into the same physical unit as the raster image file structuring apparatus. For example, the image data source 480 and/or the image data sink 490 may be part of a digital photocopier or the like.

The data/control bus 470 can be any known or later-developed device or system for connecting the controller 410, the memory 420, the file sequence circuit 430, segmentation circuit 440, the file construction circuit 450, and the input/output interface 460. In addition, the communication links 481 and 491 can be any known or later-developed devices or systems for connecting the image data source 480 and the data sink 490, respectively, to the raster image file structuring apparatus 400.

The data/control bus 470 and communication links 481, 491, 501, 511, and 521 may be a direct cable connection, a connection over a wide area network or local area network, a connection over an intranet, a connection over the Internet, or a connection over any other distributed processing network raster image file structuring apparatus. Further, it should be appreciated that the data/control bus 470 and communication links 481, 491, 501, 511, and 521 can be or include an optical, wired or wireless connection to a network. The network can be a local area network, a wide area network, an intranet, the Internet, or any other known or later-developed other distributed processing and storage network.

Image data from the image data source 480 may be a scanned image of a physical document or a photograph, a video recording, or any persistent digital representation of captured image (e.g., output from a digital camera). The image data is provided in a form of an image data file, which is constructed from set-up information and associated image data. The image data presented by the image data source 480 has been processed after capture to achieve a number of objectives. The processing typically includes, for example, normalizing the image data to eliminate capture device artifacts, color space conversions to facilitate data storage and processing, and data compression to reduce file size. In the course of image processing, image metadata may be created and preserved. This metadata may be used to modify the structure of the image and to improve the quality of the image when rendering the image. Metadata may include pixel rendering hints.

The controller 410 controls data flow between other components of the raster image file structuring apparatus 400. The memory 420 may serve as a buffer for information coming into or going out of the raster image file structuring apparatus 400. The memory 420 may store any necessary programs and/or data for implementing the functions of the raster image file structuring apparatus 400, and/or may store other types of data, such as digital ink that is electronically “drawn” on the image data, at various stages of processing.

Alterable portions of the memory 420 may be, in various exemplary embodiments, implemented using static or dynamic RAM. However, the memory 420 can also be implemented using a floppy disk and disk drive, a writable or rewritable optical disk and disk drive, a hard drive, flash memory or the like. The generally static portions of the memory 420 are, in various exemplary embodiments, implemented using ROM.

However, the static portions can also be implemented using other non-volatile memory, such as PROM, EPROM, EEPROM, an optical ROM disk, such as a CD-ROM or DVD-ROM, and disk drive, flash memory or other alterable memory, as indicated above, or the like.

After image data is received from the image data source 480 via the communication link 481, the file sequence circuit 430 sequences the file contents so that all the set-up information for the file is grouped together. Such set-up information may be sequenced to precede the image data.

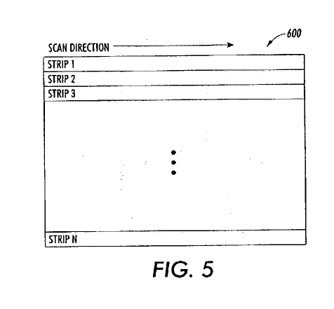

The segmentation circuit 440 apportions the image data into one or more segments. As shown in FIG. 5, an image 600 is segmented into N strips. In various exemplary embodiments, the segments are typically strips extending in a scan direction of the image data as shown in FIG. 5. However, it should be appreciated that the strips may extend in a sub-scan direction (e.g., longitudinal direction).

For example, each of the strips includes a number of scan lines (not shown). The size of a segment may be a predetermined size or the largest amount of data that will fit in the available processor data memory (not shown) at the data sink 490 for subsequent rendering of the image data, or any smaller size, but the invention is also effective with larger-sized segments, although such will require buffering (e.g., first-in-first-out buffering). In addition, each segment may have the same size. However, it should be appreciated that segments may have different sizes. In the exemplary embodiment described above, the segments are uniform in size, except that the last segment, i.e., segment N, may be of a different size.

Furthermore, in various exemplary embodiments, because of compression-related constraints for the image data, when using the JPEG format, for example, the number of scan lines is preferably evenly divisible by 8. For example, the segment of the image may have 288 scan lines for 600 dpi images, 192 scan lines for 400 dpi, 144 scan lines for 300 dpi.

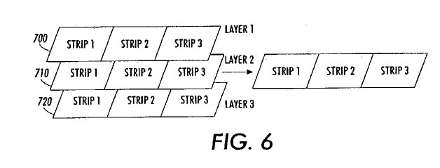

If a segment has more than one layer, such as a foreground layer 700, a mask layer 710 and a background layer 720, as shown in FIG. 6, image data of different layers may be grouped together. In embodiments, the size of a mask layer 710 for the first segment is the same as the size of the foreground layer 700 and the background layer 720 for a segment. However, a layer may have a different resolution from that of another layer(s), and therefore have a different number of the scan lines and have a different size. Furthermore, as shown in FIG. 6, the segmentation circuit 440 may construct the image data such that each segment has data for associated layers of the image data, and such that the image data is formed in a predetermined order. For example, image data for the background layer may precede that for the mask, which is followed by that for the foreground layer.

In various exemplary embodiments, each segment has information that the data sink 490 may refer to accurately reproduce each segment. For example, in TIFF, references to tags in the set-up information may be provided for each segment. In a JPEG format, a reference to quantization or Huffman tables in the set-up information may be provided for each segment.

In various exemplary embodiments, if the set-up information varies by segment, a portion or all of the set-up information may be provided to each segment such that each segment can be independently processed at the processors 500, 510 and 520.

The file construction circuit 450 constructs an output image file in which the image data is presented in the order for reproduction and/or rendering, and prepares the constructed output image data file for transmission to the data sink 490. That is, the output image data is constructed such that the segments are formed in order to be reproduced at the data sink 490. In exemplary embodiments according to this invention, the segment containing the lead edge (i.e., the part to be reproduced first) is encountered first in the file, and the image data is presented in ascending order. In other words, the file construction circuit 450 constructs the output image data file such that the first strip of the image data precedes the second strip of the image data and so on, with the final strip of the image data at the end of the file. The constructed output image data file is then made available to the data sink 490. In this way, because the segments are in the order in which they are to be consumed, the time required to, for example, start printing the first page is minimized since the image data for the lead edge is processed first. In addition, because the output image file is constructed in order for rendering, the segments can be distributed to a plurality of processors in sequence, resulting in less time required for completing the process. For example, the segment 171 may be distributed to the processor 500, while the segments 172 and 173 are distributed to the processors 510 and 520, respectively.

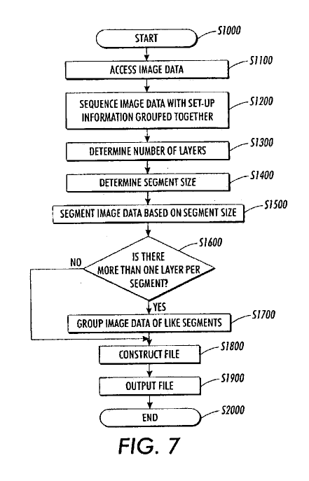

FIG. 7 is a flowchart outlining one exemplary embodiment of a method for structuring a raster image file according to this invention.

The process starts at step S1000 and continues to step S1100. In step S1100, image data is accessed, and the process continues to step S1200. In step S1200, the image data is sequenced such that different parts of the set-up information for the image data are grouped together.

Next, in step S1300, the number of layers is determined, and the process continues to step S1400. In step S1400, a segment size is determined. The segment size is typically selected to be within capacity of the processors (and to satisfy compression constraints, and may be optimized based on the number of layers, resolution of each layer, and/or the like. Then, the process continues to step S1500.

In step S1500, the image data is segmented based on the segment size. Each segment may have more than one layer of image data, and/or references to values stored in the set-up information. Next, in step S1600, a determination is made as to whether there is more than one layer in the segment. If there is more than one layer, the process continues to step S1700; otherwise the process jumps to step S1800.

In step S1700, image data of a plurality of layers for a segment is grouped. For example, the image data for all layers is grouped together in the order in which it will be reproduced.

In step S1800, an output image data file is constructed in which image data is presented in order for streamed rendering. That is, the output image data file is constructed such that the segments are in the proper order for rendering. Then, in step S1900, the constructed file is output, and the process continues to step S2000 and ends.

This invention is not limited to the above described methods and systems. Those skilled in the art will appreciate that many modifications are possible without departing from the scope of the invention. Additionally, the invention has application to any known or later developed system or device capable of rendering raster image files. It will be apparent to those skilled in the art that the methods and systems described above can be applied for generating color, gray scale and/or black and white image files.

It should be appreciated that the steps shown in FIG. 7 are described in the above order for illustration purposes, but that in various exemplary embodiments, some of the steps of structuring of the raster image file can be performed in a different order and/or with additional or fewer steps.

For example, in order to provide accurate information for streaming rendering the image data associated with a segment, there may be provided a step for determining whether the associated image data requires separate set-up information, and/or a step for structuring the image data such that each segment has the necessary set-up information. Furthermore, in the various exemplary embodiments described above, although each step for structuring the raster image data may be performed automatically, there may also be opportunity for user input at one or more stages of the process.

In the various exemplary embodiments described above, the raster image file structuring apparatus 300 can be implemented using a programmed general purpose computer or circuits. However, the raster image file structuring apparatus 300 can also be implemented using a special purpose computer, a programmed microprocessor or microcontroller and peripheral integrated circuit elements, and ASIC or other integrated circuit, a digital signal processor, a hardware electronic or logic circuit, such as a discrete element circuit, a programmable logic device, such as PLD, PLA, FPGA or PAL, or the like. In general, any device, capable of implementing a finite state machine that is in turn capable of implementing the flowcharts shown in FIG. 7, can be used to implement the raster image file structuring apparatus 300.

Each of the circuits and elements of the various exemplary embodiments of the raster image file structuring apparatus 300 described above can be implemented as portions of a suitable programmed general purpose computer. Alternatively, each of the circuits of the various exemplary embodiments of the raster image file structuring apparatus 300 described above can be implemented as physically distinct hardware circuits within an ASIC, or using FPGA, a PDL, a PLA or a PAL, or using discrete logic elements or discrete circuit elements. The particular, each of the circuits of the various exemplary embodiments of the raster image file structuring apparatus 300 described above is a design choice and will be obvious and predictable to those skilled in the art.

Moreover, the various exemplary embodiments of the raster image file structuring apparatus 300 described above and/or each of the various circuits and elements discussed above can each be implemented as software routines, managers or objects executing on a programmed general purpose computer, a special purpose computer, a microprocessor or the like. In this case, the various exemplary embodiments of the raster image file structuring apparatus 300 and/or each or the various circuits and elements discussed above can each be implemented as one or more routines embedded in the communication network, as a resource residing on a server, or the like. The various exemplary embodiments of the raster image file structuring apparatus 300 and the various circuits and elements discussed above can also be implemented by physically incorporating the raster image file structuring apparatus 300 into a software and/or hardware raster image file structuring apparatus, such as the hardware and software raster image file structuring apparatus of a web server or a client device.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope -of the invention.

What is claimed is:

1. A method of structuring image data, comprising:
accessing data including set-up information and image data;
determining a structure of the image data;
sequencing contents of the data such that parts of the set-up information that were separated in the accessed data are grouped together;
segmenting the image data into two or more segments; and
constructing output data including the set-up information and the two or more segments of the image data.

2. The method of claim 1, wherein determination of the structure of the image data includes determining a number of layers.

3. The method of claim 1, wherein sequencing the contents of the data includes sequencing the set-up information to precede the image data.

4. The method of claim 1, wherein a format of the image data includes one or more of TIFF, JPEG and GIF.

5. The method of claim 1, wherein the set-up information contains information for rendering the image data.

6. The method of claim 1, wherein each of the segments has substantially the same size except the last segment.

7. The method of claim 6, wherein the size is predetermined.

8. The method of claim 6, wherein the size is determined based on one or more of the number of layers, format of each layer, resolution of each layer, capacity of the processors.

9. The method of claim 1, wherein each segment includes at least one reference that references the set-up information.

10. The method of claim 1, wherein the segments extend in a scan direction.

11. The method of claim 1, wherein the segments include information for rendering the image data.

12. The method of claim 1, wherein the constructing step comprises:
arranging the segments in order for rendering.

13. The method of claim 12, wherein the arranging step includes arranging the segments in the order of consumption by the image sink.

14. The method of claim 1, wherein all layers of image data necessary to render a spatial segment of the image are packaged into the same segment.

15. The method of claim 14, wherein plurality of layers in arranged in sequence that corresponds to order of consumption for the imaging model.

16. A raster image data structuring apparatus, comprising:
a data sequence circuit that accesses data including set-up information and raster image data, determines a structure of the image data, and
sequences contents of the data such that parts of the set-up information that were separated in the accessed data are grouped together;
a segmentation circuits that segments the image data into two ore more segments; and
a file construction circuit that constructs output data including the set-up information and the two or more segments.

17. The system of claim 16, wherein the structure of the image data includes one or more layers

18. The system of claim 16, wherein the data sequence circuit sequences the set-up information to precede the image data.

19. The apparatus of claim 16, wherein a format of the raster image data file includes one or more of TIFF and JPEG and GIF.

20. The apparatus of claim 16, wherein the set-up information contains information for rendering the image data.

21. The apparatus of claim 16, wherein each of the segments has substantially the same size except the last segment.

22. The apparatus of claim 21, wherein the size is predetermined.

23. The apparatus of claim 21, wherein the size is determined based on one or more of the number of layers, format of each layer, resolution of each layer, capacity of the processors.

24. The apparatus of claim 17, wherein each segment includes at least one reference referencing the set-up information.

25. The apparatus of claim 17, wherein the segments extend in a scan direction.

26. The apparatus of claim 17, wherein the segments include information for rendering the image data.

27. The apparatus of claim 17, wherein the file construction circuit arranges the segments in order for rendering.

28. The apparatus of claim 27, wherein the segments are arranged in ascending count order.

29. A raster image rendering device containing the raster image data structuring apparatus of claim 17.
